(19) United States
(12) Patent Application Publication
(10) Pub. No.: US 2022/0095870 A1
(43) Pub. Date: Mar. 31, 2022

(54) AUTONOMOUS CLEANING DEVICE

(71) Applicant: SHENZHEN SILVER STAR INTELLIGENT TECHNOLOGY CO., LTD., Shenzhen (CN)

(72) Inventor: Lianrong Zheng, Shenzhen (CN)

(21) Appl. No.: 17/485,886

(22) Filed: Sep. 27, 2021

(30) Foreign Application Priority Data
Sep. 29, 2020 (CN) 202022182925.6

(51) Int. Cl. A47L 11/40; A47L 11/24; A47L 11/28; G01D 11/24

(52) U.S. Cl. CPC A47L 11/4011; A47L 11/24; A47L 2201/04; A47L 11/4061; G01D 11/245; A47L 11/28

(57) ABSTRACT

The present disclosure provides an autonomous cleaning device. The autonomous cleaning device includes a housing, a cover and a switch. The housing is provided with a sensing component, and the sensing component protrudes upward from the housing to sense surrounding environmental information of the autonomous cleaning device. The cover is connected to the housing in a positioning manner and in a way that the cover is capable of rotating downward relative to the housing, and a free end of which is located on a side close to a movement direction of the autonomous cleaning device, wherein the sensing component is located in the cover. The switch is located on a movement path of the free end of the cover, so that the free end is capable of triggering the switch during a downward rotation of the cover under force.

### CROSS-REFERENCE TO RELATED APPLICATIONS

This application is based upon and claims priority to Chinese Patent Application CN202022182925.6, filed Sep. 29, 2020, the entire contents of which are incorporated herein by reference.

### TECHNICAL FIELD

The present disclosure relates to cleaning devices, and more particularly to an autonomous cleaning device.

### BACKGROUND

The sensing component of a common cleaning robot is a single element or combined by multiple sensing elements, and the sensing component can protrude from a top wall of the housing of the cleaning robot to sense the environmental information around the cleaning robot.

The sensing component is arranged in a fixed connection, which is a threaded connection. A fixedly-connected protective cover connected to the housing by the threaded is provided to protect the sensing component. The protective cover protrudes from the top wall of the housing. When the fixedly-connected protective cover enters a low space such as the space under a sofa or a bed, the cleaning robot may be stuck in the low space. Therefore, the cleaning robot continues to run in the original running path at this space, which not only fails to continue the cleaning work, but also increases the load on the running-wheel power mechanism of the cleaning robot and reduces the service life of the running wheel power mechanism.

### SUMMARY

There is provided an autonomous cleaning device according to embodiments of the present disclosure. The technical solution is as below:

According to an aspect of embodiments of the present disclosure, there is provided an autonomous cleaning device, comprising:

a housing provided with a sensing component, wherein the sensing component protrudes upward from the housing to sense surrounding environmental information of the autonomous cleaning device;

a cover connected to the housing in a positioning manner and in a way that the cover is capable of rotating downward relative to the housing, and a free end of which is located on a side close to a movement direction of the autonomous cleaning device, wherein the sensing component is located in the cover; and

a switch located on a movement path of the free end of the cover, so that the free end is capable of triggering the switch during a downward rotation of the cover under force.

In order to better understand and implement the present disclosure, the present disclosure will be described in detail below in conjunction with the accompanying drawings.

### BRIEF DESCRIPTION OF THE DRAWINGS

FIG. 1 is a schematic structural diagram of an autonomous cleaning device of the present disclosure.

FIG. 2 is a partial enlarged view of an area A in FIG. 1.

FIG. 3 is a schematic diagram of a connection relationship between a cover and a switch.

FIG. 4 is a partial enlarged view of an area B in FIG. 3.

FIG. 5 is a schematic diagram of a connection relationship between a housing and a sensing component.

FIG. 6 is a schematic diagram of a connection relationship between the cover and a positioning member.

FIG. 7 is a side view of the cover and the housing.

FIG. 8 is a partial enlarged view of an area C in FIG. 7.

FIG. 9 is a schematic diagram of a connection relationship between the housing and the positioning member.

FIG. 10 is a schematic diagram of the connection relationship between the cover and the switch in another embodiment.

FIG. 11 is a schematic structural diagram of the housing of another embodiment.

FIG. 12 is a schematic structural diagram of a positioning member of another embodiment.

FIG. 13 is a schematic diagram of a connection relationship among the positioning member, a rotation shaft and the cover of another embodiment.

FIG. 14 is a partial enlarged view of an area D in FIG. 13.

### DETAILED DESCRIPTION

The orientation terms such as up, down, left, right, front, back, front side, back side, top and bottom mentioned or possibly mentioned in this specification are defined relative to its structure, which are relative concepts. Therefore, they may change accordingly according to different locations and different usage conditions. Therefore, these or other orientation terms should not be interpreted as restrictive terms.

The implementation manners described in the following exemplary embodiments do not represent all implementation manners consistent with the present disclosure. Rather, they are merely examples of methods consistent with some aspects of the present disclosure as detailed in the appended claims.

The terms used in the present disclosure are only for the purpose of describing specific embodiments, and are not intended to limit the present disclosure. The singular forms of “a”, “said” and “the” used in the present disclosure and appended claims are also intended to include plural forms, unless the context clearly indicates other meanings. It should also be understood that the term “and/or” as used herein refers to and includes any or all possible combinations of one or more associated listed items.

The autonomous cleaning devices can be classified into commercial cleaning robots and household cleaning robots according to use, and can be classified into automatic cleaning robots for sweeping, automatic cleaning robots for mopping, automatic cleaning robots for wiping, automatic cleaning robots for scrubbing and etc.

### Embodiment

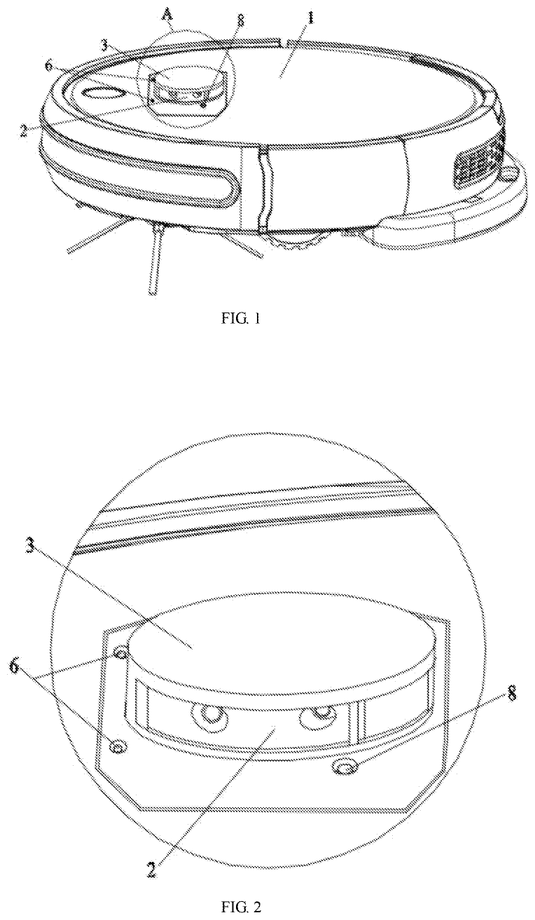

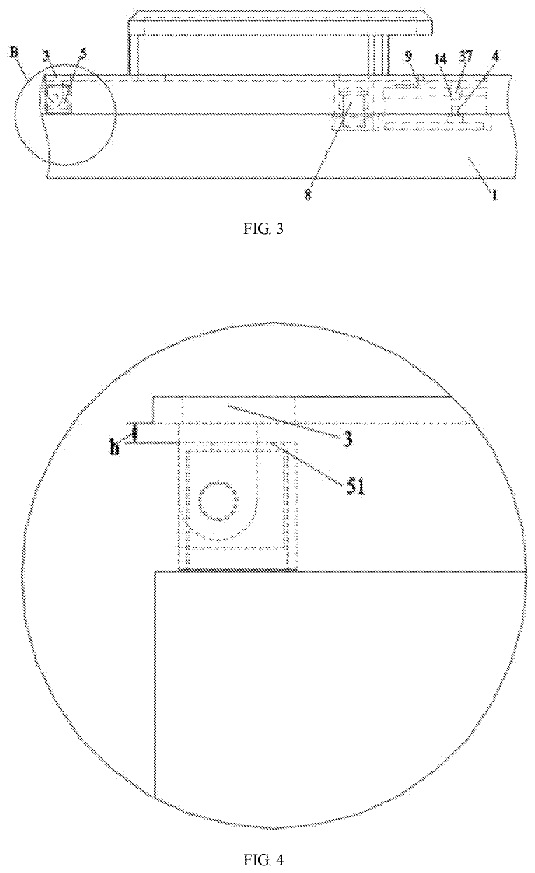

As shown in FIGS. 1-3, FIG. 1 is a schematic structural diagram of the autonomous cleaning device of the present disclosure, FIG. 2 is a partial enlarged view of an area A in FIG. 1, and FIG. 3 is a schematic diagram of a connection relationship between a cover and a switch.

The autonomous cleaning device of the present disclosure includes a housing 1, a sensing component 2, a cover 3 and a switch 4.

The housing 1 may include an upper housing and a lower housing, and can be used to mount modules such as a front impact component, a walking component, a cleaning component, a control unit, and a water tank component;

The sensing component 2 is provided in the housing 1 and electrically connected to the control unit, and the sensing component 2 protrudes upward from the housing 1 to sense environmental information around the autonomous cleaning device. The sensing component 2 may be a sensor such as a lidar, a Time of Flight (TOF) sensor, a structured light sensor or an ultrasonic sensor, which may be a single sensor or a sensor module formed by at least two sensors. The sensing component 2 is used to sense single or multiple combined environmental information features such as distance, location, image features, contours, or straight lines.

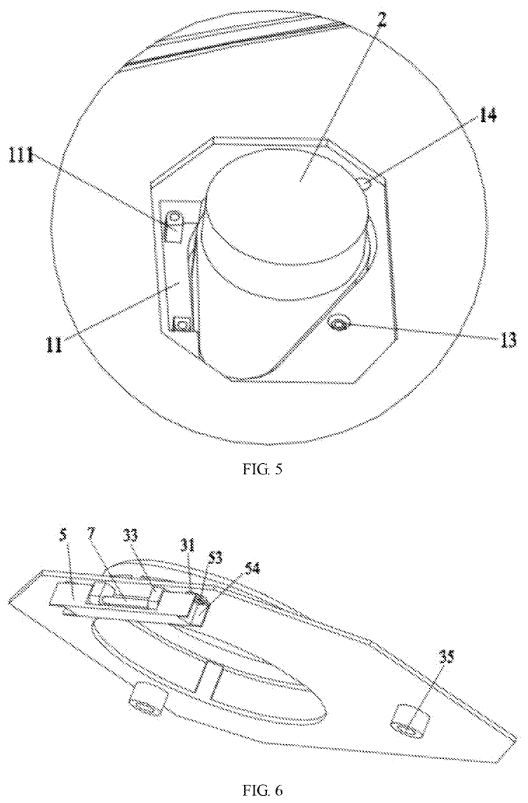

The cover 3 is connected to the housing 1 in a positioning manner, and the sensing component 2 is located in the cover 3. The cover 3 and the housing 1 are connected in a way that the cover can rotates downward relative to the housing 1, and the free end of the cover 3 is located on the side close to the movement direction of the autonomous cleaning device. The cover 3 and the housing 1 are connected in a positioning manner, so that the mounting between the body 3 and the housing 1 is more convenient. The connection in a positioning manner can be seen in FIGS. 5-6; and

The switch 4 is electrically connected to the control unit, and the switch 4 is located on the movement path of the free end of the cover 3, so that when the cover 3 rotates downward under force, the free end can trigger the switch 4. The switch 4 can be a contact switch such as a micro switch and a light touch switch, or a non-contact induction switch such as a Hall switch.

Working principle: when the sensing component 2 is about to be impacted, the cover 3 plays a protective role. When the autonomous cleaning device enters a low space such as the space under a sofa, the cover 3 rotates downward under force, and the free end can trigger the switch 4. After the switch 4 is triggered, a conduction signal is sent out. The switch 4 is connected to the control unit, so that the control unit can receive the conduction signal and output a control signal to control the autonomous cleaning device to perform actions such as stopping, changing the original movement path, thereby greatly improving the problem of continuous stuck in a low space caused by continuous original movement of the autonomous cleaning device. Specifically, the control unit can execute actions such as decelerating and retreating, accelerating and retreating, stopping movement, issuing an alarm, or shutting down after receiving the conduction signal through a preset program, thereby preventing the cleaning robot from further stuck. Of course, it can also execute actions to attempt to get out of stuck, such as accelerating forward and moving to the side.

Specifically, the free end of the cover 3 triggers the switch 4, the cover 3 is connected to the housing 1 in a way that the cover can rotate downward relative to the housing 1, and the cover 3 is connected to the housing 1 in a positioning manner. The connection relationships are as follows:

(1) The free end of the cover 3 triggers the switch 4. A second through hole 14 can be provided on the housing 1. The cover 3 has a second protrusion 37, and the second protrusion 37 is arranged at the free end of the cover 3. During the downward rotation of the cover 3 under force, the free end penetrates the second through hole 14 and triggers the switch 4 located under the second through hole 14, so that the second protrusion 37 can trigger the switch 4, and the switch 4 can be better triggered by the second protrusion 37 extending from the cover 3. The second protrusion 37 can extend from the cover 3 toward the switch 4. Specifically, the second protrusion 37 can be used to press contact switches such as micro switches and tact switches, and the second protrusion 37 can also be sensed by inductive switches such as Hall switches by movement. The protrusion 37 may have a magnet.

(2) The cover 3 is connected to the housing 1 in a way that the cover can rotate downward relative to the housing 1. This can be achieved by hinging the cover 3 with the housing 1. Specifically, the transfer is performed by the positioning member 5.

The positioning member 5 is hinged to the cover 3, and the positioning member 5 is detachably and fixedly connected to the housing 1. The positioning member 5 can be fixed on the housing 1 through a threaded connector 6 to realize a detachable and fixed connection between the positioning member 5 and the housing 1. The threaded connector 6 can be a screw or a bolt. The structure of the positioning member 5 can be seen in FIG. 6.

At this time, the cover 3 can rotate relative to the housing 1. In order to limit the rotation angle of the cover 3, a limit mounting member 8 can be provided for limiting the upward rotation angle of the cover 3, and the positioning member 5 is set to have a planar shape. A first gap h is reserved between the positioning member 5 and the cover 3 that can prevent the cover 3 from rotating downward. The top wall 51 and the first gap h limit the downward rotation angle of the cover 3, or the downward rotation angle can be restricted by setting a barrier on the downward movement path of the free end of the cover 3. The first gap h and the top wall 51 can be seen in FIGS. 4 and 8.

(3) The cover 3 is connected to the housing 1 in a positioning manner. The housing 1 can be provided with a positioning portion 11, and the positioning member 5 is matched with the positioning portion 11, so that the cover 3 is connected to the housing 1 in a positioning manner. The cover 3 can be positioned on the housing 1 with the positioning member 5, which is quick and easy to mount.

In order to prevent the cover 3 from contacting the sensing component 2 during the rotation, there is a second gap between the cover 3 and the sensing component 2 which can prevent the cover 3 from directly contacting the sensing component 2 during the rotation.

It should be noted that, in order to reset the cover 3 when the force on the cover 3 is canceled, an elastic reset member 9 is provided, and is provided between the cover 3 and the housing 1. Specifically, the elastic reset member 9 can be a spring, a torsion spring or an elastic sheet. The elastic sheet may be a strip-shaped elastic piece made of plastic material. One end of the strip-shaped elastic piece is fixedly arranged on the housing 1, and the other end abuts against the bottom wall of the cover 3.

As shown in FIG. 4 in combination with FIG. 3, FIG. 4 is a partial enlarged view of the area B in FIG. 3.

In order to facilitate to fix the positioning member 5 to the housing 1 through the threaded connector 6, the positioning member 5 has a top wall 51 with a planar shape. In order to realize that the cover 3 can rotate relative to the housing 1, there is a first gap h between the top wall 51 and the cover 3 that can allow the free end to rotate downward to trigger the switch 4. The top wall 51 with the planar shape can form a mounting surface for easy mounting, and the existence of the top wall 51 can limit the movement of the free end between the positioning member 5 and the cover 3. The first gap h is provided for allowing the free end to have a movement space to rotate downward to trigger the switch 4. A proper first gap h can limit the downward rotation range of the free end, and the details are as shown in FIG. 8.

As shown in FIGS. 5-6, FIG. 5 is a schematic diagram of a connection relationship between the housing and the sensing component, and FIG. 6 is a schematic diagram of the connection relationship between the cover and the positioning member.

The positioning member 5 is matched with the positioning portion 11. The positioning portion 11 has a first mounting column 111, and the positioning member 5 has a first groove 54. The first groove 54 is matched with the first mounting column 111 to arrange the positioning member 5 on the housing 1 in a positioning manner. First, the positioning member 5 is arranged on the housing 1 in a positioning manner, and then the positioning member 5 is fixedly connected to the housing 1, so that the positioning member 5 is connected to the housing 1 in a positioning manner. The shape of the first mounting column 111 may be a cylindrical shape, a square column shape, or a mixed shape of a column and a square column as shown in the figure.

Of course, the overall shape of the positioning portion 11 can also be matched with the positioning member 5 to achieve a positioning connection between the positioning member 5 and the housing 1, and then the cover 3 is hinged on the positioning member 5 to achieve the purpose of a positioning connection between the cover 3 and the housing 1. Specifically, the positioning member 5 has a square column shape as a whole, and the positioning portion 11 has a square opening as a whole, so that the entire positioning member 5 can be connected to the housing 1 in a positioning manner.

The detachable and fixed connection between the positioning member 5 and the housing 1 can be achieved by a threaded connector 6. The positioning member 5 has a first mounting hole 53, and the threaded connector 6 is threadedly connected to the first mounting column 111 through the first mounting hole 53, so that the positioning member 5 is fixedly connected to the housing 1. By providing the first mounting hole 53 on positioning member 5, and providing the first mounting column 111 on the positioning portion 11, the threaded connector 6 is used to connect the positioning member 5 to the housing 1 with the positioning portion 11, so that the positioning member 5 is fixedly connected to the housing 1, and the cover 3 hinged on the positioning member 5 can rotate relative to the housing 1.

In order to provide a wrench space for the threaded connector 6, the cover 3 has a second mounting hole 31. The threaded connector 6 penetrates the second mounting hole 31 to threadedly connect the positioning member 5 to the first mounting column 111. By providing the second mounting hole 31 on the cover 3, the threaded connector 6 can penetrate the second mounting hole to fixedly connect the positioning member 5 and the cover 3. At this time, the head and the rod of the threaded connector 6 pass through the second mounting hole 31, that is, the second mounting hole 31 can accommodate the head. The second mounting hole 31 may not restrict the threaded connector 6, and the second mounting hole 31 serves to provide a wrench space for the threaded connector 6.

It should be noted that the hinged connection between the cover 3 and the positioning member 5 can be realized by the rotation shaft 7, and the details are as follows:

The rotation shaft 7 is respectively connected to the positioning member 5 and the cover 3, so that the cover 3 can rotate around the axis of the rotation shaft 7 as a center of rotation. Through the rotation shaft 7, the cover 3 can rotate downward relative to the housing 1.

For the connection between the rotation shaft 7 and the cover 3, the cover 3 may be provided with a hinge seat 33 matched with the rotation shaft 7, and the hinge seat 33 is provided with a hole matched with the rotation shaft 7. The hinge seat 33 on the cover 3 is connected to the rotation shaft 7, so that the cover 3 and the positioning member 5 are hinged.

When in use, the positioning member 5 and the cover 3 are hinged through the rotation shaft 7, the cover 3 with the positioning member 5 is connected to the housing 1 through the positioning portion 11 in a positioning manner. And then the threaded connector 6 penetrates the second mounting hole 31 of the cover 3. Both the head and the rod of the threaded connector 6 pass through the second mounting hole 31, and do not fix the cover 3. The second mounting hole 31 accommodates the head, and the positioning member 5 is fixedly connected to the housing 1 through the first mounting hole 53 and the first mounting column 111. The first mounting column 111 may be provided with a threaded hole.

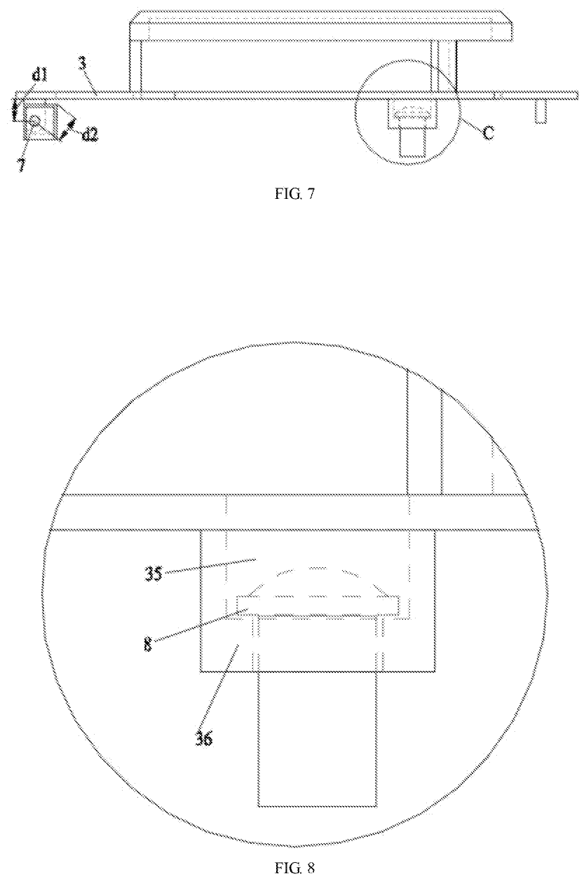

As shown in FIGS. 7 and 8 in combination with FIG. 5, FIG. 7 is a side view of the cover and the housing, and FIG. 8 is a partial enlarged view of the area C in FIG. 7.

In order to limit the upward rotation range of the cover 3, a limit mounting member 8 is provided between the cover 3 and the housing 1. The housing 1 has a second mounting column 13, and the cover 3 has a third mounting hole 35. The limit mounting member 8 passes through the third mounting hole 35 and is fixedly connected to the second mounting column 13. The head of the limit mounting member 8 is accommodated in the third mounting hole 35, and does not fix the cover 3. The cover 3 without a limit portion 36 can freely rotate upward. The limit portion 36 extends in the third mounting hole 35 toward the second mounting column 13. The limit mounting member 8 has a head, and the limit portion 36 is located below the head to limit the upward movement range of the cover 3 with the limit portion 36.

Specifically, the limit mounting member 8 can be a truss head screw or a common screw with elastic washers. At this time, the elastic washer and the screw head of the common screw form the head of the limit mounting member 8.

In order to limit the downward rotation range of the cover 3, there is a first distance d1 between the rotation shaft 7 and the cover 3, and there is a second distance d2 between the end of the positioning member 5 facing the movement direction of the autonomous cleaning device and the rotation shaft 7. The first distance d1 is smaller than the second distance d2, so that the downward rotation range of the cover 3 can be restricted. The first distance d1 is smaller than the second distance d2, therefore, when the positioning member 5 is connected to the housing 1 in a positioning manner and the cover 3 rotates downward relative to the positioning member 5, the bottom wall of the cover 3 abuts the end of the positioning member 5 facing the movement direction of the autonomous cleaning device, and the cover 3 cannot continue to rotate downward, thereby limiting movement range of the cover 3 to rotate downward.

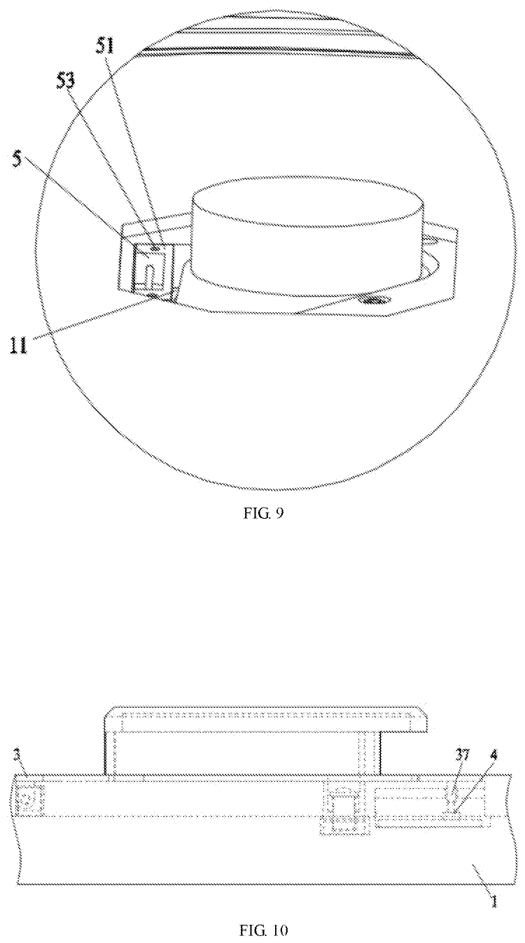

As shown in FIG. 9 in combination with FIGS. 5-6, FIG. 9 is a schematic diagram of the connection relationship between the housing and the positioning member.

In order to facilitate the understanding of the fitting relationship between the positioning portion 11 and the positioning member 5, the positioning member 5 without hinging the cover 3 is connected to the housing 1 in a positioning manner. At this time, the first groove 54 on the positioning member 5 is sleeved on the first mounting column 111 on the positioning portion 11. The positioning member 5 with the square column shape is sleeved on the positioning portion 11 with the square column shape; the first mounting hole 53 on the positioning member 5 is located above the threaded hole of the first positioning column, and the second mounting hole 31 of the cover 3 is located above the first mounting hole 53 of the positioning member 5. Moreover, since the positioning member 5 is in the shape of a square column, and the top wall 51 of the positioning member 5 is planar shaped, thereby facilitating the threaded connector 6 to penetrate the second mounting hole 31 and pass through the first mounting hole 53 and the threaded hole of the first mounting column 111 to fixedly connect the positioning member 5 and the housing 1.

As shown in FIG. 10, FIG. 10 is a schematic diagram of the connection relationship between the cover and the switch in another embodiment.

In another embodiment, the elastic reset member 9 is eliminated between the cover 3 and the housing 1, which is replaced with the second protrusion 37 extending in the direction of the switch 4 and abutting the switch 4. When the cover 3 is slightly impacted, the switch 4 can conduct for the first time, and the elastic piece of the switch 4 itself can be used for resetting. There is no need to provide an elastic reset member 9 between the cover 3 and the housing 1.

Of course, at this time, an elastic reset member 9 can also be provided between the cover 3 and the housing 1, so the reset action can be more sensitive.

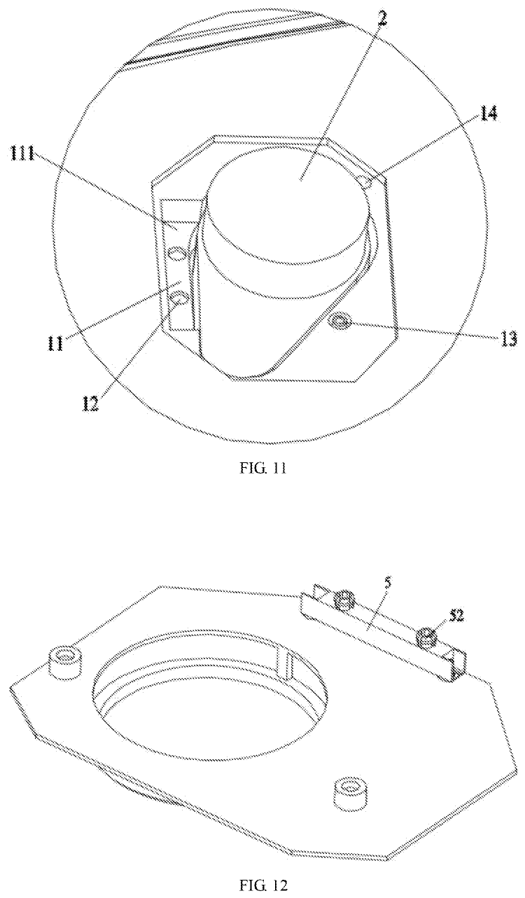

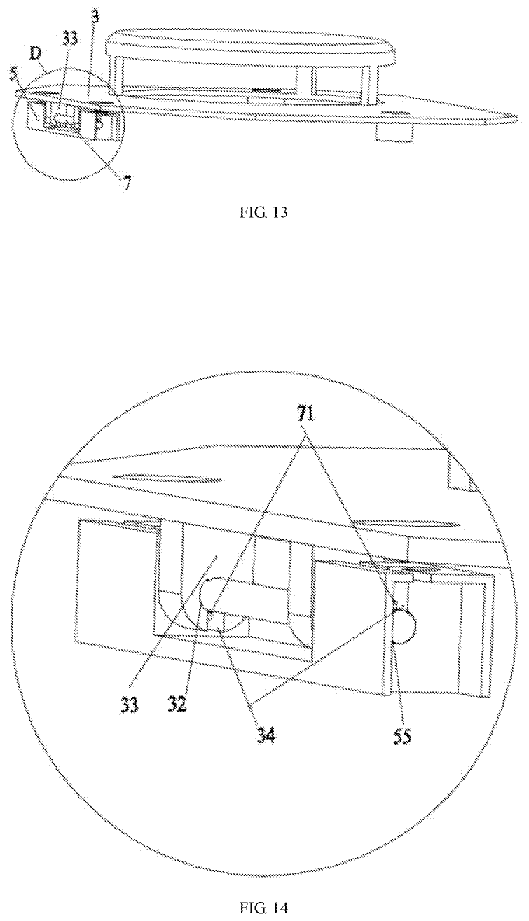

As shown in FIGS. 11 to 14, FIG. 11 is a schematic structural diagram of the housing in another embodiment, FIG. 12 is a schematic structural diagram of the positioning member in another embodiment, FIG. 13 is a schematic diagram of a connection relationship among the positioning member, a rotation shaft and the cover in another embodiment, and FIG. 14 is a partial enlarged view of the area D in FIG. 13.

In another embodiment, in order to improve production efficiency, openings 34 are provided at the position where the cover 3 is matched with the rotation axis 7 and at the position where the positioning member 5 is matched with the rotation axis 7, and the hinge seat 33 and the positioning member 5 are set as elastic structural members, thereby greatly improving the mounting speed. A first protrusion 71 is provided on the rotation shaft, and the first protrusion 71 is located in the opening 34 to limit the rotation angle of the cover 3 relative to the positioning member 5. At the same time, the detachable and fixed connection between the positioning member 5 and the housing 1 is adopted as a plug-in connection instead of a threaded connection, and the details are as follows:

The detachable and fixed connection between the positioning member 5 and the housing 1 is adopted as a plug-in connection instead of a threaded connection. The positioning member 5 has a first plug-in portion 52, the housing 1 has a second plug-in portion 12, and the first plug-in portion 52 is matched with the second plug-in portion 12, so that the positioning member 5 and the housing 1 are fitted in a plug-in manner. The fitting in the plug-in manner makes the positioning member 5 faster to be mounted. Compared to the structure of threaded connection, the second mounting hole 31 for passing through a bolt on the cover 3 is omitted, and the cover 3 is easier to be form and the structure is simple. Specifically, the second plug-in portion 12 is a first through hole, and the first plug-in portion 52 has at least two arc-shaped segments with the same diameter. Each the arc-shaped segment is arranged at equal angle along the same central axis, so as to enclose the first plug-in portion 52 that fits in the first through hole. The head of each arc-shaped segment has an arc protrusion extending from the radial direction of the arc-shaped segment. The arc-shaped segments arranged at equal angles along the same central axis enclose the first plug-in portion 52 where the second plug-in portion 12 can be inserted, so that the first plug-in portion 52 can be inserted in the first through hole with different diameters. Therefore, the first plug-in portion 52 has a high degree of adaptability. By extending the arc protrusion in the radial direction on the head of each arc-shaped segment, the first plug-in portion 52 can be clamped in the first through hole to realize the plug-in connection. At this time, the first plug-in portion 52 is directly pressed in the second plug-in portion 12 to achieve quick mounting. The first plug-in portion 52 may be an independent structural member, and is fixed to the positioning member 5 by a fixed connection means such as screw connection, plug-in connection. Or, the first plug-in portion 52 may be a structural member integrally connected with the positioning member 5.

Openings 34 are provided at the position where the cover 3 is matched with the rotating shaft 7 and at the position where the positioning member 5 is matched with the rotating shaft 7. The positioning member 5 has a second groove 55, and the cover 3 has a third groove 32. Each of the second groove 55 and the third groove 32 has an opening 34, and two side walls of the opening 34 form two limit ends. The position of the rotation shaft 7 corresponding to the opening 34 is provided with a first protrusion 71. Specifically, when the cover 3 has two third grooves 32 and the positioning member 5 has two second grooves 55, the position of the rotation shaft 7 corresponding at least one third groove 32 and at least one second groove 55 may be provided with the first protrusion 71. When the cover 3 rotates relative to the positioning member 5, the first protrusion 71 rotates between the two limit ends. When the first protrusion 71 abuts against one of the limit ends of the second groove 55 and one of the limit ends of the third groove 32 at the same time, the cover 3 stops rotating. The opening 34 cooperates with the first protrusion 71 so that the movement range of the rotating shaft 7 is limited between the two limit ends of the second groove 55 and the two limit ends of the third groove 32, thereby avoiding the action range of the free end from being too large, and solving the problem of easy failure of contact switches such as tact switches and micro switches. Therefore, the failure rate is small. The first protrusion 71 may protrude from the cylindrical surface of the rotating shaft 7.

In order to improve the mounting speed, the hinge seat 33 and the positioning member 5 are further set as elastic structural members on the basis of the openings 34 on the second groove 55 and the third groove 32. The cover 3 has a hinge seat 33, and the third groove 32 is provided on the hinge seat 33. The hinge seat 33 has elastic deformation ability, and the positioning member 5 has elastic deformation ability, so that the rotation axis 7 can enter the second groove 55 or the third groove 32 from the opening 34. The existence of the opening 34 makes the mounting of the rotating shaft 7 more convenient. During mounting, the rotating shaft 7 can be pressed to insert into the second groove 55 from the opening 34 on the second groove 55. And then the cover 3 is pressed, and the rotating shaft 7 is inserted into the third groove 32 from the opening 34 on the third groove 32, thereby completing the hinge between the cover 3 and the positioning member 5.

Compared to the traditional technique, the autonomous cleaning device of the present disclosure is provided with a cover 3, which is connected to the housing 1 in a positioning manner, so that the cover 3 and the housing 1 can be mounted faster. The cover 3 is connected to the housing 1 in a way that the cover 3 can rotate downward relative to the housing 1. The free end of the cover 3 is located on the side close to the movement direction of the autonomous cleaning device. A switch 4 electrically connected to the control unit is provided on the movement path of the free end of the cover 3. The sensing component 2 of the autonomous cleaning device is located in the cover 3, so that the cover 3 plays a protective role when the sensing component 2 is about to be impacted. When the autonomous cleaning device enters a low space such as the space under a sofa, since the cover 3 is forced to rotate downward, the free end can trigger the switch 4, and the switch 4 sends a conduction signal after being triggered. Since the switch 4 is connected to the control unit, the control unit can receive the conduction signal and output a control signal to control the autonomous cleaning device to perform actions such as stopping and changing the original movement path, thereby greatly improving the problem of continuous stuck caused by the continuous original movement of the autonomous cleaning device in the low space. The autonomous cleaning device of the present disclosure has the characteristics of improving stuck problem, quick mounting and simple structure.

The above-mentioned embodiments only express several embodiments of the present disclosure, and the description is relatively specific and detailed, but it should not be understood as a limitation on the scope of the patent. It should be pointed out that for those of ordinary skill in the art, without departing from the concept of the utility model, several modifications and improvements can be made, and these all fall within the protection scope of the present disclosure.

What is claimed is:

1. An autonomous cleaning device, comprising:
a housing provided with a sensing component, wherein the sensing component protrudes upward from the housing to sense surrounding environmental information of the autonomous cleaning device;
a cover connected to the housing in a positioning manner and in a way that the cover is capable of rotating downward relative to the housing, and a free end of which is located on a side close to a movement direction of the autonomous cleaning device, wherein the sensing component is located in the cover; and
a switch located on a movement path of the free end of the cover, so that the free end is capable of triggering the switch during a downward rotation of the cover under force.

2. The autonomous cleaning device of claim 1, further comprising:
a positioning member hinged with the cover, and detachably and fixedly connected to the housing, wherein the housing has a positioning portion, and the positioning member is matched with the positioning portion to connect the cover to the housing in a positioning manner.

3. The autonomous cleaning device of claim 2, wherein the positioning member has a top wall with a planar shape, and a first gap is provided between the top wall and the cover to allow the free end to rotate downward to trigger the switch.

4. The autonomous cleaning device of claim 2, wherein the positioning portion has a first mounting column, the positioning member has a first groove, and the first groove is matched with the first mounting column to arrange the positioning member on the housing in the positioning manner.

5. The autonomous cleaning device of claim 4, further comprising:
a threaded connector passing through a first mounting hole of the positioning member and threadedly connected to the first mounting column, to fix the positioning member to the housing.

6. The autonomous cleaning device of claim 5, wherein the cover has a second mounting hole, and the threaded connector penetrates the second mounting hole to threadedly connect the positioning member to the first mounting column.

7. The autonomous cleaning device of claim 2, further comprising:
a rotation shaft respectively connected to the positioning member and the cover, so that the cover is capable of rotating around an axis of the rotation shaft.

8. The autonomous cleaning device of claim 7, wherein there is a first distance between the rotation shaft and the cover, there is a second distance between an end of the positioning member facing the movement direction of the autonomous cleaning device and the rotation shaft, and the first distance is smaller than the second distance.

9. The autonomous cleaning device of claim 7, wherein the cover is provided with a hinge seat with a hole to match with the rotation shaft.

10. The autonomous cleaning device of claim 9, wherein openings are provided at the position where the cover is matched with the rotation axis and at the position where the positioning member is matched with the rotation axis, and the hinge seat and the positioning member are set as elastic structural members.

11. The autonomous cleaning device of claim 10, wherein a first protrusion is provided on the rotation shaft and located in the opening to limit rotation angle of the cover relative to the positioning member.

12. The autonomous cleaning device of claim 11, wherein two side walls of the opening form two limit ends, and the first protrusion is able to rotate between the two limit ends, when the first protrusion abuts against one of the limit ends, the cover stops rotating.

13. The autonomous cleaning device of claim 12, wherein the positioning member has a second groove, and the cover has a third groove, wherein each of the second groove and the third groove has one opening.

14. The autonomous cleaning device of claim 2, further comprising:
a limit mounting member penetrating a third mounting hole of the cover and is fixedly connected to a second mounting column of the housing, wherein a limit portion extends in the third mounting hole toward the second mounting column, the limit mounting member has a head, and the limit portion is located below the head.

15. The autonomous cleaning device of claim 1, further comprising:
a positioning member connected to the housing in a plug-in manner, wherein the positioning member has a first plug-in portion, the housing has a second plug-in portion, and the first plug-in portion is matched with the second plug-in portion.

16. The autonomous cleaning device of claim 15, wherein the second plug-in portion is a first through hole, and the first plug-in portion has at least two arc-shaped segments with the same diameter, wherein each the arc-shaped segment is arranged at equal angle along the same central axis, so as to enclose the first plug-in portion that fits in the first through hole.

17. The autonomous cleaning device of claim 16, wherein the head of each arc-shaped segment has an arc protrusion extending from a radial direction of the arc-shaped segment.

18. The autonomous cleaning device of claim 1, wherein the cover has a second protrusion provided at the free end of the cover, wherein the free end is capable of triggering the switch via the second protrusion during the downward rotation of the cover under force.

19. The autonomous cleaning device of claim 1, wherein there is a second gap between the cover and the sensing component, which is capable of preventing the sensing component from directly contacting the sensing component during a rotation of the cover.

20. The autonomous cleaning device of claim 1, further comprising:
an elastic reset member arranged between the cover and the housing to reset the cover when force on the cover is canceled.
